(19) United States
(12) Patent Application Publication
(10) Pub. No.: US 2006/0160570 A1
(43) Pub. Date: Jul. 20, 2006

(54) Communication network terminal, a terminal accessory device and an assembly containing the terminal and the accessory device

(76) Inventor: Mikko Kamarainen, Turku (FI)

Correspondence Address: Schwegman, Lundberg, Woessner & Kluth, P.A., P.O. Box 2938, Minneapolis, MN, 55402, US

(21) Appl. No.: 11/283,496

(22) Filed: Nov. 18, 2005

Related U.S. Application Data
(63) Continuation of application No. PCT/FI04/00298, filed on May 18, 2004.

(30) Foreign Application Priority Data
May 21, 2003 (FI) 20030766
Oct. 3, 2003 (FI) 20031443

(51) Int. Cl. H04B 1/38; H04M 1/00

(52) U.S. Cl. 455/557

(57) ABSTRACT

A mobile terminal (MS) and a remote unit (RU) communicate via a short-range wireless interfaces (LR, LR′). Each comprises a memory (ME, ME′) processor (PR, PR′). The complexity of the combination of the mobile terminal and the remote unit is lowered by having a character generator logic (CG) only in the mobile terminal that does not character data via the short-range wireless interface (LR) to the remote unit. Thus the remote unit needs no internal character generation logic.

### RELATED APPLICATIONS

This application is a continuation under 35 U.S.C. 11(a) of PCT/FI2004/000298, filed May 18, 2004, and published in English on Dec. 2, 2004 as WO 2004/105322 A1, which claimed priority to Finland Application No. 20030766, filed May 21, 2003, and Finland Application No. 20031443, filed Oct. 3, 2003, which applications and publication are incorporated herein by reference.

### BACKGROUND OF THE INVENTION

The present invention is generally a terminal for a mobile communication and an accessory device and/or an assembly with such a terminal.

The network of the invention is intended for any open or closed, circuit- and/or package-switched and/or router-based network. Among such networks are

PTN networks (Public Telephone Networks) based on telecommunication standards and typically analog or digitally switched;

PLMN networks (Public Land Mobile Networks), such as GSM, EDGE and 3G and other mobile phone networks;

PDN networks (Public Data Networks) based on data transfer standards and typically package-switched;

Ipv3 (IP, Internet Protocol) and wireless and wired local and area networks based on its later versions, or WLANs (Wireless Local Area Networks), LANs (Local Area Networks), WANs (Wide Area Networks), as well as wireless and wired IP networks;

television and telecommunication or data transfer networks based on cable network standards. For the sake of simplicity, these networks are henceforth referred to as the communication network according to the invention. At the same time, it should be emphasized that in terms of the present invention, the communication network is not an essential element of the present invention, per se, as it essentially relates to the interface between the communication-network terminal and its linked accessory device, as well as terminal and accessory device solutions in support thereof.

The terminal according to the invention is intended for any communication or terminal device, computer, server and/or base station capable of one-way and/or two-way communication. Among such devices are, for example,

mobile communication or terminal devices wirelessly linked to a communication network and intended for telecommunication and/or data transfer, such as various mobile stations and computers;

communication or terminal devices linked through a wired connection to a communications network and intended for telecommunication and/or data transfer, such as telephones, workstation or server computers, whereby the terminal device may contain a fixed and a mobile unit;

various communication network access servers, and base stations;

stationary or mobile communication or terminal devices that are stationary or optionally linked to a communication network, such as telephones or computers;

various alphanumerical devices exhibiting video or still-image and/or other media, etc., such as television sets, indicator and advertising boards and devices;

data-processing, data transfer and/or PDA (Personal Digital Assistance) devices, computer devices, etc., equipped with a data-transfer interface, but with no data-transfer link to a communication network.

For the sake of simplicity, such devices are henceforth referred to only as terminals according to the invention, while emphasizing that in terms of the present invention, the terminal is not an essential element of the present invention, per se, as it essentially relates to the interface between the terminal and its linked accessory device, and terminal and accessory device solutions in support thereof.

However, as preferred examples of typical terminal devices can, be mentioned various xDMA mobile stations intended for voice and/or data communication, e.g., GSM mobile stations based on TDMA, and third-generation or 3G mobile stations, such as UMTS mobiles stations, various intelligent telephones, such as Symbian®, Symbian®/Series 60, MS®-Smartphone, Linux®-based or similar intelligent phones, various PDA (Personal Digital Assistance) devices and various computers, such as desktop, portable and pocket computers.

It is already known that a mobile phone may be connected wirelessly with, for example, an earpiece-microphone set in order to facilitate or enable the use of the mobile phone while driving a vehicle, or with a computer in order to use and/or update the data stored in mobile-phone memory. Such a separate display unit is available as an in-car attachment for Nokia® 810 mobile telephone, for example.

### BRIEF DESCRIPTION OF THE INVENTION

An aspect of the invention is to solve the problem of replacing data transfer on the file/data level by image data transfer. Another aspect of the invention is to expand the capabilities of the accessory device and its way of thinking in connection with the terminal. A third aspect of the invention is to arrange a wireless interface between the terminal and the accessory device, allowing data processing to be simplified and obtaining an embodiment, whereby all or at least an essential part of the application routines occur in the terminal, thus removing the need to perform for the accessory device the same applications that are already available in the terminal. A fourth aspect of the invention is to improve its usefulness by ensuring that the manually operated application user interface of the accessory device is similar to the terminal itself. A fifth aspect of the invention is to remove the need to synchronize the data used by the applications and enable single-data storage in one place.

In an embodiment, the terminal according to the invention generally has the features as follows: A mobile terminal, including: a memory and processor for executing applications; a character generator operable to convert displayable character data to pixel data to be displayed; a short-range wireless interface capable of communicating with a separate remote unit. The separate remote unit includes a display unit and an input device for receiving user input from a user. The separate remote unit further includes the short-range wireless interface supports a protocol that permits an arbitrary remote unit to cooperate with an arbitrary mobile terminal. The mobile terminal is operable to send the converted pixel data and not displayable character data via the short-range wireless interface to the remote unit. Accordingly, the remote unit needs no character generator.

In other embodiment, the mobile terminal does not include a display unit or keypad. In an embodiment, the mobile terminal includes an internal display unit and that it is operable to power down the internal display unit in response to receiving user input from the remote unit. In an embodiment, the mobile terminal includes a first display buffer for an internal display unit and a second display buffer to support a remote unit having a display unit with a different resolution and/or color scheme from that of the internal display unit.

In an embodiment, an accessory device according to the invention generally has the features: optional input devices, a display unit for showing data to the user, and a local data-transfer interface for the accessory device, through which the accessory device may be connected wirelessly with the terminal in order to establish a data transfer link by way of a terminal local data-transfer interface. The data transfer link between the accessory device and the terminal applies a protocol that supports data transfer between the terminal and the accessory device. The accessory device receives image data from the terminal over a wireless data-transfer link, whereby the accessory device displays on its display unit the received image data in an unconverted fashion.

In an embodiment, the accessory device receives only image data. In an embodiment, the accessory device together with the terminal form a data transfer system, in which the user interface client application adapted for the accessory device draws the terminal UI to be transmitted to the accessory device display unit by the terminal user-interface server application. In an embodiment, the input devices arranged for the accessory device include a keyboard, buttons, controls, a touch-screen display, or a wireless control unit, control and/or request signals or commands for accessory device input and transmission by the terminal. In an embodiment, the accessory device is provided with a GPS antenna in order to receive GPS data, the accessory device transmits the received GPS data as character data over a wireless link to the terminal to be processed by the GPS application, and the accessory device receives over a wireless link the results produced by the GPS application as image data to be shown on the accessory device display. In an embodiment, the accessory device is set up for voice recognition. In an embodiment, the accessory device's local, data-transfer interface is supported by a short-range wireless link, for example, Bluetooth™, WLAN, IrDA (Infrared Data), RF, a short-range transmitter-receiver link or a transponder link, and the like. In an embodiment, the accessory device is an accessory or peripheral display, selected from a group including mobile-phone car-terminals; desktop computers; portable computers, pocket computers; network or access servers or server software; cameras; and devices typically constituting independent devices, such as navigation devices, special display, advertising and indicator boards, television sets, video projectors, and computer displays. In an embodiment, in the entity forming the user, terminal and accessory device for voice transfer assembly includes a third unit for user-voice reception and terminal-voice repetition, i.e., a second accessory device next to the first one for producing the voice transfer through the accessory device at least for the terminal, whereby optionally the voice is transferred between the second and first accessory device by one link, and the voice and other data is carried between the terminal and the first accessory device through a second link, and there is only one local data-transfer interface in the first accessory device, which handles the data transfer of either link; the voice is transferred from the voice source directly to the terminal through the second accessory device, whereby between the terminal and accessory device two different links exist and the terminal local data-transfer interface handles the data transfer of either link; the first data transfer interface is located in the terminal and both the voice and other-data transfer between the terminal and first accessory device and the voice are transferred through the second link between the first and second accessory device, and in the second accessory device there is one local data-transfer interface and in the first accessory device, there are two local data transfer interfaces.

In an embodiment, an assembly containing a communication device or terminal for the transmission and/or reception of data, and at least one separate accessory device, whereby the terminal of the assembly includes memory and a processor for executing the application, character-generator devices converting character data so as to be displayed as image data, and a local-data transfer interface, through which the terminal is wirelessly linked to a separate accessory device in order to transfer data to the said accessory device; which includes a local data-transfer interface for the accessory device, through which the accessory device is linked to the terminal, and which accessory device includes devices receiving information to be displayed as visible data; whereby the wireless data transfer link between the terminal and the accessory device applies a protocol in the assembly that supports data transfer between the terminal and accessory device. The data transfer of the convertor, intended to convert the character data to image data and needed for elimination in the accessory device, between the communication network terminal and the accessory device over a wireless connection involves image data rather than character data.

In an embodiment, the terminal and accessory device form a data-transfer system, wherein the server application of the system-user interface is adapted for the terminal device, and wherein the client application of the system user interface is adapted for the accessory device, whereby the display accessory or peripheral device is selected from a group that includes mobile-phone car-terminals, desktop computers, portable computers, pocket computers, network or interface-server or server software, cameras, and devices typically constituting independent devices, such as navigation devices, various display, advertising and indicator boards, television sets, video projectors and computer monitors. In an embodiment, the link between the terminal and the local data transfer interfaces of the accessory device is a short-range link, preferably Bluetooth™, WLAN, IrDA (Infrared Data), RF, a short-range wireless transmitter-receiver link, a transponder link, and the like. In an embodiment, the design of the terminal incorporates a terminal display or server application or part adapted for the terminal application level repeating the terminal and transmitting image data corresponding to the terminal to the accessory device. In an embodiment, the terminal has a buffer for the accessory device display unit. In an embodiment, the design of the terminal incorporates a display or server application or part adapted for the terminal application level drawing the whole terminal for the terminal buffer, from which the display image corresponding to the terminal is transferred as image data to the accessory device. In an embodiment, the terminal buffer, through which the image data adapted for the accessory device are transmitted to the accessory device, is arranged for the terminal, allowing for different resolutions of the displays for the terminal and accessory device. In an embodiment, the buffer enables different resolutions of the accessory device and terminal to be run simultaneously. In an embodiment, the design of the terminal incorporates a display or server application or part for the accessory device adapted at a lower level relative to the operating-system application level, preferably at operating-system level, drawing the whole terminal for the terminal buffer, from which the display image corresponding to the terminal UI is transferred as image data to the accessory device. In an embodiment, the terminal capable of one-way and/or two-way communication is selected from a group that includes: mobile terminals linked wirelessly to a communication network and intended for telecommunication and/or data transfer, such as various mobile phones and computers; communication network access servers, and base stations; stationary or mobile terminals either in fixed or linked connection with a communication network, such as telephones and computers, as well as various alphanumerical terminals exhibiting video and/or still-image and/or other media, such as television sets, indicator and advertising boards and devices, and the like. In an embodiment, the terminal is a mobile station. In an embodiment, the accessory device is provided with a GPS antenna for receiving GPS data, the accessory device transmits the received GPS data over a wireless link as character data to the terminal to be processed in a GPS application adapted for the terminal, and the terminal transmits the results produced by the GPS application over a wireless link to the accessory device in order to display the image data on the accessory-device display. In an embodiment, the image data are compressed in the terminal and decompressed in the accessory device, whereby the compression/decompression may be a general data compression, an image compression or a moving-image-compression system, such as Zlib, JPEG or MPEG-4, or another compression/decompression system. In an embodiment, voice, multimedia, or data supplementing the image data besides image data transferred over a wireless link are transferred. In an embodiment, the terminal and/or the accessory device are arranged for voice recognition.

The basic idea of the present invention is to replace the data transfer on the file/data level with image data transfer, whereby the user terminal UI (User Interface) transfers image data in an unconverted fashion to the accessory device, allowing simplification of the data transfer and especially of the accessory device. It should be mentioned that the conversion and compression according to the invention are separable from one another.

A feature of the present invention is that the terminal server application transfers the terminal user interface in order to realize the accessory-device client application. As the terminal device contains the assembly user interface, the terminal device functions as an integral server unit and likewise, the accessory device functions integrally as a client unit irrespective of which integral unit is sending or receiving the impulses.

The connection of the present invention is ascertained to ensure that the conversion according to the invention is linked to the data conversion performed by the character generator, whereby character data are converted to image data. The terminal device is typically provided with such a character generator; however, the accessory device according to the invention has no character generator, and shows the image data received from the terminal device over a wireless link in an unconverted fashion on its display. Thus, the terminal according to the invention transmits to the accessory device image data to be shown on the accessory device display immediately or after decompression. The image data may be transferable data for display image elements (pixels) to be shown directly by the accessory device display, or data that may be transferred to display image elements (pixels) after decompression.

In order to minimize the image transfer delay, for example, the image transfer uses compression in the terminal and decompression in the accessory device. There are many compression methods for general-data compression, voice-data compression, image-data compression or moving-image compression. A person skilled in the art will be familiar with different image compression/decompression methods, and various solutions for performing compression/decompression are commercially available, which is why only a few compression/decompression methods are referred to here by way of example, i.e., JPEG and MPEG-4.

The connection of the present invention is ascertained to ensure that the control data according to the invention refer, for example, to a command or message, such as key or touch-screen data, GPS (Global Positioning System) data or other data not initially intended to be displayed on the accessory device display; image data refer to compressed or uncompressed data signals transferred over a wireless link from the terminal to the accessory device, such as JPEG, MPEG4 or bit-card data; character data refer to binary-code and/or displayable data signals that are unconverted by the character generator; voice data refer to analog or digitally coded/decoded data signals for voice transfer; multimedia data refer to voice and image-containing data signals.

The wireless link between the terminal and the local data transfer interface of the accessory device is a short-range link, preferably Bluetooth™, WLAN, IrDA (Infrared Data), RF, a transmitter/receiver or transponder link, and the like.

The entity thus constitutes a request/response-based, data-transfer system, in which the client application enables the user to control the assembly and operate the server application at the terminal. The accessory device itself presents no obstacle to using the present invention, since by adapting the client application to the desired accessory device, any type of display accessory device may support the terminal and function as a terminal accessory or parallel device. Among typical accessory devices are mobile-phone car terminals, desktop computers, portable computers, pocket computers, network or interface servers or server software, cameras, devices constituting independent devices, such as navigation devices, various display, advertising and indicator boards, television sets, video projectors, and computer monitors.

The advantages obtained by the present invention can be stated generally like this: Complementing the terminals, accessory devices with improved utility and ergonomics may be used. Through certain preferable embodiments of the invention to be described later may be produced, e.g., an accessory display replacing the display of the mobile phone for car usage that is larger and/or with a higher resolution and/or otherwise of better quality than the display of the mobile phone accompanying the user. Such an improved-quality, accessory display would make possible a more ergonomic and thus safer operation of the mobile phone, when traveling. A problem, however, consists in accustoming the user with the unusual user interface of the mobile phone display, the need of often repeating the application data synchronization (e.g., switches, calendar data, images), and the need to download applications used in mobile stations, such as calendars and e-mail programs, to the accessory display. In this example, the accessory display may preferably be linked wirelessly with a mobile station, the mobile station being in the driver's pocket or bag, when traveling by car, and the accessory display can easily be installed, as well as moved from one vehicle to another.

### BRIEF DESCRIPTION OF THE DRAWINGS

The invention is explained below by way of an example of a preferred embodiment only, wherein the communication network is a mobile station network, the terminal is a mobile station and the accessory device linked wirelessly to the mobile station an accessory display device, referred to in the attached drawings, wherein

FIG. 1 is a general depiction of the preferred embodiment of the invention, wherein the mobile station network terminal is linked wirelessly with the accessory device;

FIG. 2 is a block diagram showing the assembly of the invention according to the embodiment in FIG. 1;

FIG. 3 shows the operation of the invention according to the embodiment in FIG. 2;

FIG. 4 shows a first design implementation of the Symbian®/Series 60 terminal according to the present invention, including an accessory-device server application adapted to the application level, which repeats the terminal display, allowing, for example, the well-used, active keys of a touch screen to be drawn, if required, in the accessory device window (e.g., the area which does not draw a terminal display, whose resolution may be lower than that of the accessory device window), so that their depression will generate key depressions on the terminal side;

FIG. 5. shows a second design implementation of the Symbian®/Series 60 terminal according the present invention, including an accessory-device server application adapted to the application level, which draws the whole terminal user interface server application for its own buffer, which transmits the adapted image to its accessory device, using, for example, resolution and color-scale information, allowing different resolutions to be applied simultaneously in the terminal and accessory devices, and

FIG. 6. shows a third design implementation of the Symbian®/Series 60 terminal according to the invention, including an accessory-device server part, or application or part, adapted at lower level relative to the application level, which draws the whole terminal user interface for the terminal display or memory buffer, which transmits the adapted image to its accessory device, using, for example, resolution and color-scale information, allowing different resolutions to be applied simultaneously in the terminal and the accessory device.

### DETAILED DESCRIPTION OF THE INVENTION

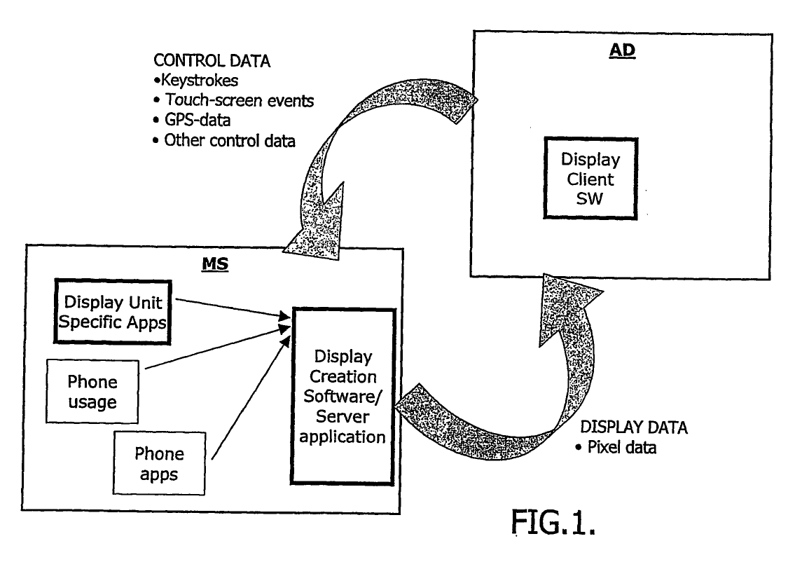

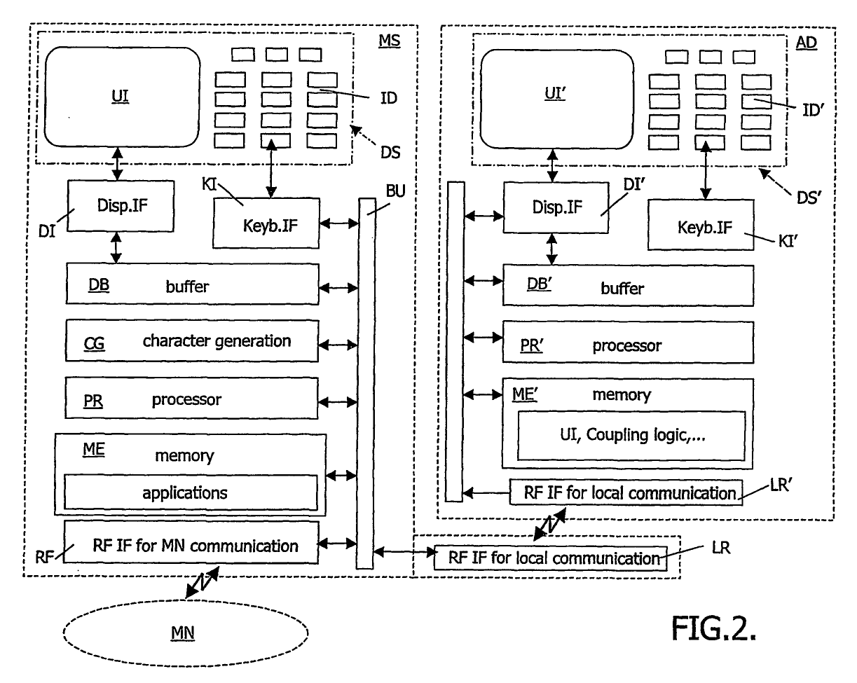

Reference is made to FIG. 1. generally showing an embodiment of the present invention. The terminal MS of the mobile communication network MN (shown in FIG. 2), typically a mobile phone, is linked wirelessly with an accessory device AD, which is typically an accessory display device, and which together with the terminal forms the client-server, data-transfer system, wherein the application 1 forming the server or display is adapted for the terminal and the client or display application 2 is adapted for the accessory device. To illustrate the terminal entity, FIG. 1 of the terminal shows the display-unit control applications (Display Unit Specific Apps), the phone-operating system (phone usage) and the phone applications (phone apps).

The terminal MS according to the invention transmits data over a wireless connection to the accessory device AD to be shown on the accessory device display, which data was previously converted to image data in the terminal. Thus, the transfer of data to be shown on the display according to the invention are image data rather than character data, so that a data conversion tool is not necessarily needed in the accessory-device assembly according to the invention, which is why the transfer from the terminal to the accessory device of data to be shown similarly in the accessory device is simpler than according to prior art. It should, however, be mentioned that in order to minimize the time lag, any preferred compression/decompression method may be used, including Zlib, JPEG and MPEG-4. Since a particular compression/decompression solution does not limit the scope of the present invention, other compression/decompression solutions are possible.

The embodiment shown in FIG. 1 also illustrates how the accessory device AD, besides being merely a display device, may also be a device communicating with the terminal MS. The accessory device may therefore transmit over a wireless link terminal control data, such as control signals or commands, e.g., key or touch-screen depression data, GPS (Global Positioning System) or other data not originally intended to be shown on the accessory device display. Using control data, it is possible to request the terminal to transmit, if required, suitable or supplementing image data or transmit information to the terminal, so that the terminal may appropriately adapt the image data to be transmitted to the accessory device, or the information needed to run the application in the terminal. Besides displayable image data, the terminal may transmit in the same way as the accessory device non-displayable control data over a wireless link. Such control data are for example information that may be needed for establishing the wireless data-transfer link between the terminal and the accessory device. The wireless link between the local data-transfer interfaces LR, LR′ according to the invention is preferably a short-range wireless link. Among such a wireless links are Bluetooth™, WLAN, IrDA (Infrared Data), RF, or wireless, short-range transmitter/receiver or transponder links, and the like.

The accessory device AD is optionally equipped with a GPS antenna in order to receive GPS data, whereby the GPS data received by the accessory device may be transmitted as control data over a wireless link to the terminal MS. Thus, all GPS data being control and/or request data transmitted to the accessory device and utilized by the GPS application may be fully adapted for the MS terminal and then run completely in the accessory device, and the accessory device may be used to show only the results produced by the GPS application on its display UI′, DS′.

FIG. 2 is a block diagram illustrating an embodiment of the invention. Reference signs MS and AD denote the two major functional blocks according to the invention, namely the terminal and accessory device, respectively. An illustrative example of the terminal MS according to the invention is a mobile terminal that is capable of communicating with a mobile network MN. The terminal MS comprises a user interface UI, which in turn comprises a display DS and an input device ID that is shown as a keypad, but a touch sensitive screen or any other available data entry technology can be used. The displays DS and input device ID are controlled by a display interface DI and keyboard interface, respectively. The implementation of the interfaces DI, KI, depend on the nature of display and input device, and for the purposes of the present invention, the display and input device, along with their respective interfaces, can be entirely conventional. For example, a liquid-crystal display and conductive rubber-mat keypad are commonly used in mobile terminals. The display interface obtains its data via a display buffer DB. In order to display characters, there is a character generator CG. A processor PR controls the overall operation of the terminal. A memory ME stores applications (programs) for the processor, as well as temporary and permanent data. A radio frequency section RF serves as an interface to the mobile network MN. A bus BU connects the major functional blocks of the terminal.

Note that the character generator CG is shown as a distinct hardware block, but it can be implemented as a routine that is stored in the memory ME and executed by the processor PR, as is well known to those familiar with graphical user interfaces.

The accessory device AD comprises many functional blocks that are similar of analogous to their counterparts in the terminal MS. The reference signs of the functional blocks of the accessory device AD have an apostrophe appended to them, and only the differences to their counterparts in the terminal MS will be described. The processor PR′ in the accessory device and the applications in the memory ME′ only relate to local functions within the accessory device AD. In other words, the processor PR′ in the accessory device does not execute any high-level applications, such as address book functions or the like. The local functions of the accessory device AD include a local user interface (display DS′, input device ID′) and coupling logic. The coupling logic couples a specific accessory device with a specific terminal. The accessory device AD connects to the terminal MS via a local wireless link, for example a RF-link (RF, Radio Frequency), for which there are local RF-interface circuits LR, LR′. A well-known example of such a local wireless link is known as Bluetooth™. The Bluetooth™-link and interfaces therefor with required coupling logic are commonly available. In addition to the Bluetooth™-link there are several other well-known possibilities for the wireless-link solutions to be utilized between the accessory device AD and the terminal MS. As examples of short distance wireless links can be further mentioned Bluetooth™, WLAN, IrDA, different RF-links and corresponding short-range, transmitter/receiver links and transponder links.

According to the invention, the accessory device AD does not include a character generator. Rather, the character generator CG of the terminal MS converts displayable characters to image data, and the converted image data is sent to the accessory device AD via the wireless link. In the accessory device AD, the image data is stored in the display buffer BF′ and displayed via the display interface DI′ and display DS′. Note that the display buffers BF, BF′ are shown as separate blocks, but they may be implemented as dedicated sections of the memories ME, ME′.

The embodiment shown in FIG. 2 is only an illustrative and non-restrictive example, and many variations are possible. For example the terminal MS may be implemented without a permanent display DS and/or input device ID, whereby only the corresponding elements DS′, ID′, in the accessory device AD are used.

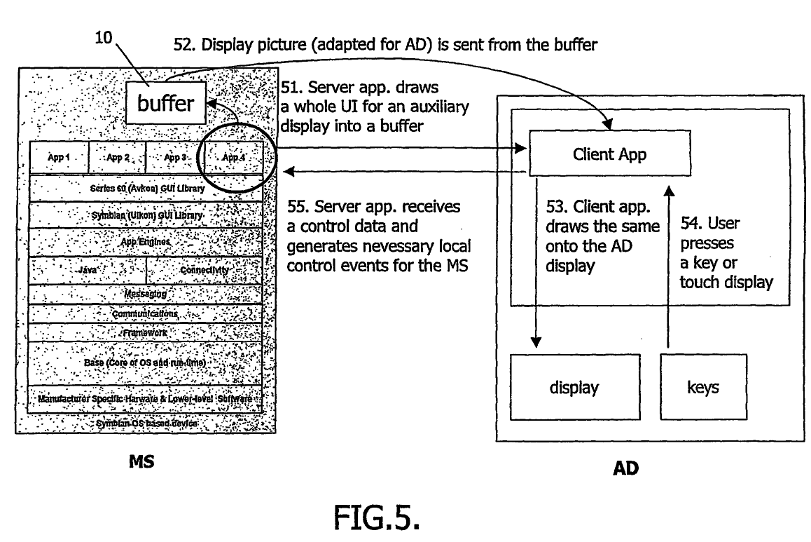

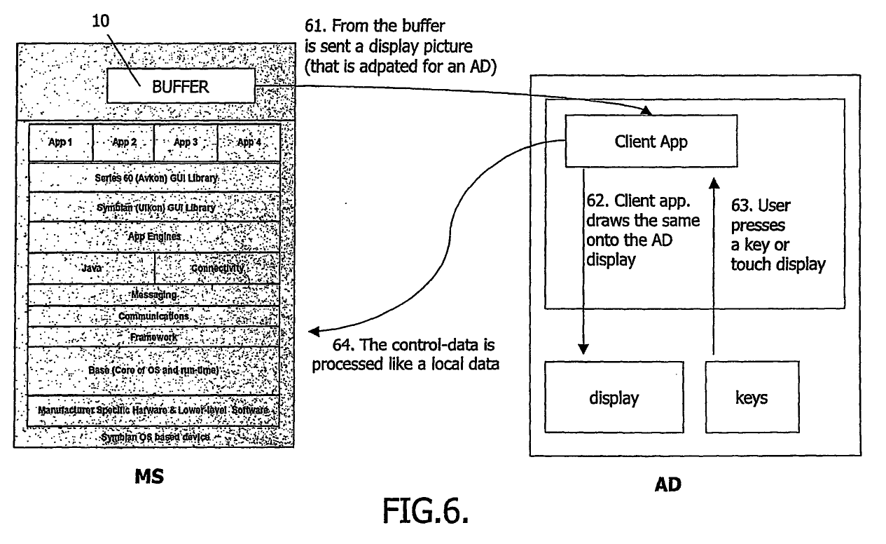

Another embodiment relates to a disadvantage of a basic form of the invention, i.e., the fact that the two displays DS, DS′, must be run at the same resolution if they are to share a common character generator CG. In order to run the two displays at different resolutions, the terminal MS should have a dedicated display buffer (see FIGS. 5 and 6) for the accessory device AD. Instead of a different resolution, or in addition to it, the accessory device AD can be run at a color scheme different to that of the terminal MS. For example, the accessory device AD and terminal MS may have different numbers of shades of color, or one of them may have a color display, while the other is black and white, etc.

Those skilled in the art will appreciate that the accessory devices can be simplified by generating all image data in the terminal and transmitting only image data from the terminal to the accessory device. Not only is the character generation omitted from the accessory device, but so is much of the user interface software. Because the accessory device only displays pre-generated image data, the display of the accessory device can be implemented with low-intelligence, raster-scan functions. Accordingly, the accessory device AD according to the invention can be adapted to many units with a raster-scan display, such as for example a television set, a computer monitor, a video-show device, Also, the accessory device processor can be greatly simplified, which results in lower manufacturing costs and energy consumption. Accordingly, such low-cost accessory devices can be installed more or less permanently in cars or on office desks, and users do not have to touch their terminals in order to use them.

In a further preferred embodiment of the invention, the terminal MS may save battery power by shutting down its internal display DS if it detects user activity via the accessory device AD.

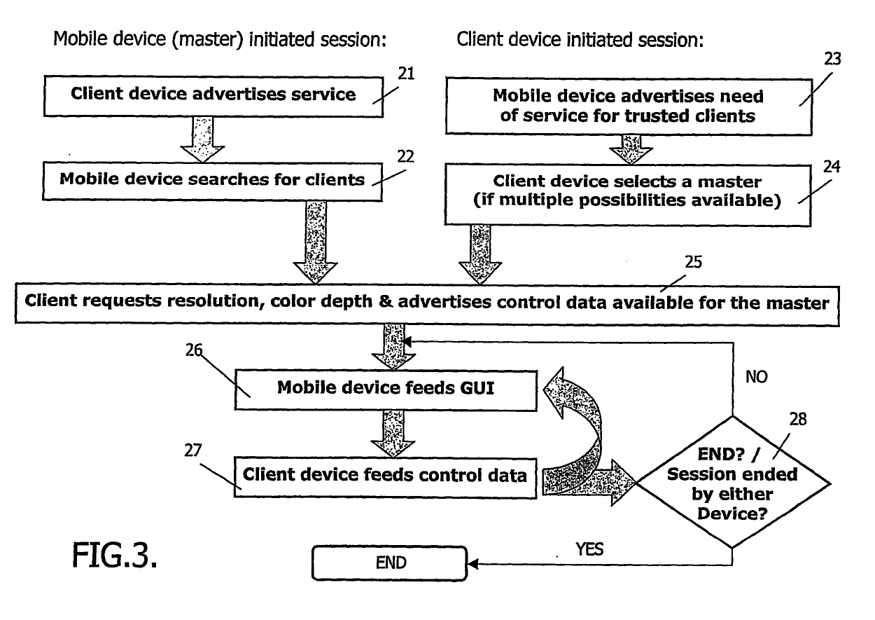

FIG. 3 is a flow chart illustrating the operation of the invention. Steps 21 and 22 relate to a session initiated by the terminal (master). In step 21, the local RF interface circuit LR′ for the wireless link in the accessory device AD advertises its services (existence). In step 22, the local RF interface circuit LR for the wireless link in the terminal MS searches for an available accessory device AD (client), In step 25, the accessory device AD requests display parameters, such as resolution, color depth, etc. The accessory device AD also advertises control data (user input) available to the terminal MS. In step 26, the terminal feeds image data, obtained via the wireless local interface, to the display DS′ of the accessory device. In step 27, the accessory device AD feeds control data (user input) obtained from its local input device 10′ to the terminal MS. In step 28, the terminal (master) checks whether the session is to end. If so, the session is executed. Otherwise, the process returns to step 26.

Steps 23 and 24 relate to a session initiated by the accessory device AD (client). In step 23, the terminal MS advertises a need for trusted accessory devices (clients). In step 24, the accessory device AD selects a master terminal MS, if multiple masters are available, i.e., within the coverage area of the local wireless link.

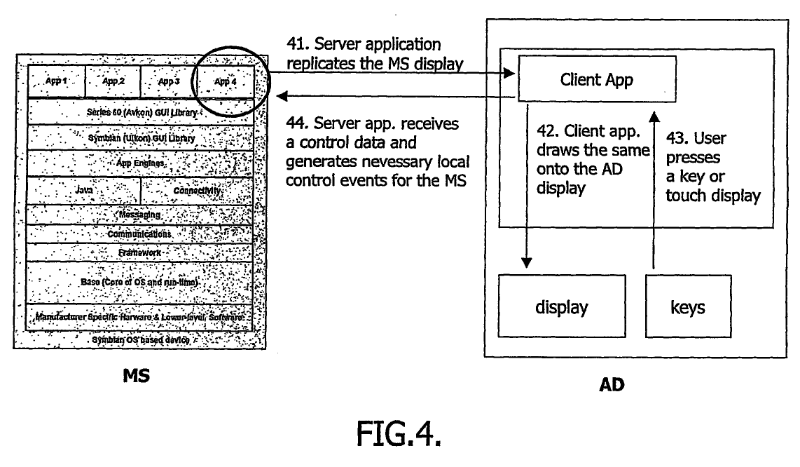

Reference is made to FIGS. 4, 5 and 6, showing embodiments of the Symbian®/Series 60 terminal MS application design according to the invention. The operation of the terminal MS is essentially based on multi-layered application groups, or so-called application stacks, including a lower level, operating-system layer and an upper-level application layer, which may be the top layer.

In the first embodiment shown in FIG. 4, a display or server application or part is arranged at the terminal MS application stack level. In step 41, the terminal MS repeats the terminal UI and transmits the image data corresponding to the accessory device UI unchanged to the accessory device AD, whereupon in step 42, the accessory-device client application draws the terminal UI on the accessory device display UI′, DS′. The display/server application arranged for the terminal thus reads “as is” the image data shown in the display window DS′, copying, for instance, the image data from the terminal display buffer or other similar level provided with a server-application interface, and transmits the read image data unchanged to the accessory device. Therefore, in the embodiment shown in FIG. 4, the different resolutions of the terminal and the accessory device are not detected by the image data transmitted to the accessory device AD, however, the terminal display is repeated “as is” in the accessory device display, i.e., the terminal image resolution and other parameters do not change. Optionally, simpler resolution scaling may be done, however. This way, a display buffer may arranged both for both the terminal and the accessory device.

In the embodiment shown in FIG. 4 may be optionally drawn on the accessory device AD display UI′, DS′, for example in an area not drawing the terminal MS, such as a mobile phone, a display whose resolution is lower than that of the accessory device display window DS′, to be used, e.g., as keyboard ID′ via a touch-screen.

If the accessory device AD supports two-way data transfer, it is provided with data-input devices ID′, such as an integrated, wired or wireless keyboard, buttons, controls or a touch screen. In step 43, the input devices provide such input. In step 44, the control data are transmitted over a wireless link to the terminal MS, where the server application receives the control data and generates its terminal control data, with which the server application generates the local controls needed in the terminal. In this way, the transmission via a wireless link may be a data transfer of the request/response type.

Naturally, the transfer of image data from the terminal MS to the accessory device AD may also be activated by a terminal impulse, when the accessory device is within the area covered by the short-range link between the terminal and the accessory device, whereby it is preferred that the impulse for image-data transfer is provided by the terminal, and the impulse received in response is accessory device display UI′, DS′ parameters such as resolution and color-scale parameters.

Reference is made to FIG. 5, showing the second embodiment terminal application stack provided, as in the embodiment in FIG. 4, with a display or server application or part arranged for the application level, and with its own buffer 10 for the accessory device AD display UI′, DS′.

An essential difference of the embodiment shown in FIG. 4 is that the image data are transmitted in the terminal MS to the accessory device AD through the server application's own buffer 10, whereby the image data may be adapted so as to be ready for the accessory device. Thus, the image-data transfer may detect the different resolutions of the terminal and accessory device displays UI, DS; UI′, DS′ while different resolutions may be run in the terminal and accessory device.

The server application in the embodiment shown in FIG. 5 therefore takes care of drawing the whole terminal UI for the server application's own buffer 10, thereby enabling the server application in the terminal MS to draw for its own buffer 10 the desired image data, which are preferably ready to be shown on the accessory device AD display DS′. These image data may be adapted for the terminal display UI, DS, and processed, they may be identical to the terminal display UI′, DS′, or the image data may contain image elements (pixels) that are invisible or not shown on the terminal display.

In the embodiment shown in FIG. 5, the display or server application or part, adapted at the application level of the terminal MS application stack, in step 51 essentially draws the whole terminal UI for the accessory device AD for its own buffer 10, from which processed, supplemented and/or unprocessed image data corresponding to the terminal UI are transferred in step 52 to the accessory device as adapted for showing on the accessory device display UI′, DS′. In step 53. the accessory-device client application then draws the terminal UI on the accessory device display.

As in the embodiment in FIG. 4, and provided the accessory device AD supports two-way data transfer, the accessory device is equipped with data input devices ID′, such as an integrated, wired or wireless keyboard, buttons, controls or a touch screen. In the embodiment shown in FIG. 5, input is achieved by the input devices in step 54. The control data in step 55 are transmitted over a wireless link to the terminal MS, where the server application receives the control data and generates its terminal control data, from which the server application generates local controls needed by the terminal. Thus, the image-data transmission over a wireless link may be a data transfer of the request/response type.

Naturally, the transfer of image data from the terminal MS to the accessory device AD may also be activated by a terminal impulse, if the accessory device is within the area covered by the short-range link between the terminal and the accessory device, whereby it is preferred that the impulse for image-data transfer is provided by the terminal and the impulse received in response is accessory device display parameters such as resolution and color-scale parameters for adapting the image data to be transmitted to the accessory device and processed in the accessory device display UI′, DS′.

Reference is made to FIG. 6, in which the third embodiment differs from the embodiments shown in FIGS. 4 and 5 most essentially in that the display or server application or part is adapted at a lower application level for the accessory device AD, preferably at the operation-system level, which matches per se known drawing embodiments for portable computer displays. It generally applies that the server application may be adapted at any application-stack level at which the terminal MS's own display is processed and responses handled. It is essential in the embodiment shown in FIG. 6 that, the accessory device AD display UI′, DS′ may be updated (refreshed) simultaneously with the terminal display UI, DS, in similar fashion as in the embodiment shown in FIG. 5.

The server application in the embodiment shown in FIG. 6 uses the display or memory buffer for the terminal MS display UI, DS to update the accessory device AD display UI′, DS′, whereby the whole terminal UI is drawn by the server application for the buffer as adapted for the accessory device AD and retransmitted as image data to the accessory device.

The image data in the embodiment shown in FIG. 6 are transmitted by the server application in the terminal MS to the accessory device AD through the display or memory buffer in the terminal making the image data ready and adapted for the accessory device. Thus different resolutions of the terminal and accessory device displays UI, DS; UI′, DS′ may be detected in the image-data transfer, and different resolutions may be run simultaneously in the terminal and in the accessory device.

The server application in the embodiment shown in FIG. 6 therefore takes care of drawing the whole terminal UI in the display or memory buffer of the terminal MS, allowing the server application in the terminal MS to draw the image data needed for the buffer and preferably ready to be shown on the accessory device AD display UI′, DS′. These image data may be adapted for processing in the terminal display UI, DS, or may be identical with the terminal display UI′, DS′, or the image data may contain image elements (pixels) that are invisible or not shown on the terminal display.

Essentially, for the embodiment shown in FIG. 6, the terminal UI in step 61 transfers the memory or display buffer of the terminal MS unchanged, processed or supplemented to the accessory device AD over a wireless link to be shown on the accessory device display UI′, DS′. In step 62, the client application of the accessory device draws the terminal UI on the accessory device display.

Likewise, in the embodiment shown in FIG. 4, if the accessory device AD supports two-way data transfer, the accessory device may be provided with data input devices ID′, such as an integrated, wired or wireless keyboard, buttons, controls or a touch screen. In the embodiment shown in FIG. 6, the input devices in step 63 provide the input. The control data in step 64 are transmitted over a wireless link to the terminal MS, where the server application receives the control data and generates control data for the terminal, with which it generates local controls needed in the terminal.

It will be apparent to a person skilled in the art that, as the technology advances, the inventive concept can be implemented in various ways. The invention and its embodiments are not limited to the examples described above but may vary within the scope of the claims.

The terminal and accessory device may form the client/server, data-transfer system, in which the server application used by the terminal user interface is set up for the terminal and the client application is set up for the accessory device, whereby the display accessory or parallel device is preferably selected from a group including a mobile phone car terminal, a desktop computer, a portable computer, a pocket computer; a network or interface server or server software, a camera, devices typically functioning as independent devices, such as GPS (Global Positioning System) and navigation devices; various display, advertising and indicator boards; television sets, video projectors, and computer monitors.

It should be mentioned that an accessory device was described previously and defined in the attached claims as essentially receiving image data and displaying them unconverted. It is, however, obvious to a person skilled in the art that the accessory device may receive audio, multimedia or other data supplementing the image data. Moreover, the accessory device may be set up for voice recognition. Such solution implementations are known, per se, to a person skilled in the art, and their disclosure together with and/or in addition to the disclosure of the basic idea in the figures according to the present invention do not limit the scope previously defined in the attached claims nor do they reduce the novelty or inventiveness of the above-mentioned basic idea.

The data transfer between the terminal and accessory device may also involve voice transfer. Some possible solutions for terminal voice transfer and the formation of the terminal and accessory device group are presented in the following list and examples: A third unit, i.e., a third accessory device for voice processing is added to the assembly next to the second one. Thus voice transfer may be handled through the first accessory device AD for the terminal MS and optionally further for the data transfer network MN, or directly for the terminal.

The voice is transferred from the voice source to the accessory device AD, there being only one wireless link between the terminal MS and the accessory device. Thus, the accessory device is preferably in so-called multipoint mode, dividing the time of the terminal and voice source direction [incomplete sentence?].

The voice is transmitted directly from the voice source to the terminal MS (the two different links between the terminal and accessory device AD and the data transfer interface LR are in the multipoint mode, dividing the time between the data and voice link.

There is one local data transfer interface LR in the terminal MS and in the voice source there is also one local data transfer interface, and in the accessory device AD, there are two local data-transfer interfaces LR′. Thus, the accessory-device, data-transfer interfaces are not in multipoint mode.

Within the context of this invention, the term remote unit means a unit having a wireless connection to the terminal and hardware for implementing the terminal's user interface. The user interface hardware comprises a display unit and input means, such as a keypad or stylus input. An advantage of the invention is that the remote unit's cost and complexity can be reduced. Accordingly, such remote units can be used in applications that would be prohibitively expensive with prior art technology. For instance, a permanent remote unit for a mobile terminal can be installed in a car. The in-car remote unit couples with the driver's terminal, which can remain in the driver's pocket or bag.

The fact that the terminal sends only pixel data and character data for the visual data means that the terminal may send character data to the remote unit if the character data is not to be displayed. For instance, the character data may be required in a coupling process between the terminal (master) and the remote unit (client).

In addition to simplifying the construction of the separate display unit, the invention brings about the advantage that the user interfaces of the terminal and display unit are similar. Thus there is less to learn than in a system with separate user interfaces for the terminal and display unit.

A slight disadvantage caused by the invention is that the displays in the terminal (if it has a display) and in the separate display unit must be dimensioned similarly, as measured in pixels. In other words, it is difficult to operate the terminal's internal display with a resolution slightly different from that of the separate display unit. If the displays have vastly different resolutions, the display with the higher resolution can duplicate or triplicate the displayable pixels. However, it is possible to run the display of the terminal and the separate display unit at different resolutions with a display buffer dedicated to each display.

In some embodiments of the invention, the terminal does not have a physical user interface at all. As used herein, the term physical user interface means an interface that outputs physical visual or aural signals to the user or receives keyed or spoken commands from the user. Rather the terminal has a wireless interface to a separate remote unit. To display characters, the terminal converts the characters to pixels, which are then transmitted via the wireless interface to the remote unit. The remote unit is also sensitive to the user's key presses, either because the display screen is touch-sensitive, or because the remote unit has a keypad. Either way, the user's key presses are transmitted via the wireless interface to the terminal.

Separating the remote unit from the terminal brings about certain further advantages. For example, some users are concerned about health effects of radio frequency transmission. By separating the remote unit from the terminal, the terminal can be positioned farther away from the user's brain. Further, a remote unit with a wireless interface can serve as a convenient platform for adding more functionality to the terminal/display combination. For example, the separate remote unit may comprise a satellite-positioning device, the position information of which is transmitted via the wireless interface to the terminal, for the use of a positioning application. If such a system is installed in a car, the satellite-positioning device may have access to an external antenna, but the antenna needs no wired connection to the positioning application. Even without an external antenna, the remote unit may be located near the car's windshield for better satellite reception than is possible with the terminal which may reside in the user's pocket.

All publications, patents, and patent documents are incorporated by reference herein, as though individually incorporated by reference. The invention has been described with reference to various specific and preferred embodiments and techniques. However, it should be understood that many variations and modifications may be made while remaining within the spirit and scope of the invention.

1. A mobile terminal, comprising:
a memory and processor for executing applications;
character generator operable to convert displayable character data to pixel data to be displayed;
a short-range wireless interface capable of communicating with a separate remote unit:
the separate remote unit comprises a display unit and an input device for receiving user input from a user; and
the short-range wireless interface supports a protocol that permits an arbitrary remote unit to cooperate with an arbitrary mobile terminal;
wherein the mobile terminal is operable to send the converted pixel data and not displayable character data via the short-range wireless interface to the remote unit; and whereby the remote unit needs no character generator.

2. A mobile terminal according to claim 1, wherein the mobile terminal is free of at least one of a display unit and a keypad.

3. A mobile terminal according to claim 1, wherein the mobile terminal comprises an internal display unit and that it is operable to power down the internal display unit in response to receiving user input from the remote unit.

4. A mobile terminal according to claim 1, wherein a first display buffer for an internal display unit and a second display buffer to support a remote unit having a display unit with a different resolution and/or color scheme from that of the internal display unit.

5. An accessory device for the terminal, which accessory device optionally includes input devices, a display unit for showing data to the user, and a local data-transfer interface for the accessory device, through which the accessory device may be connected wirelessly with the terminal in order to establish a data transfer-link by way of a terminal local data-transfer interface, whereby the data-transfer link between the accessory device and the terminal applies a protocol that supports data transfer between the terminal and the accessory device, which receives only image data from the terminal over a wireless data-transfer link and displays on its display unit the received image data in an unconverted fashion, wherein the accessory device together with the terminal forms a data transfer system, in which the user interface client application adapted for the accessory device draws the terminal to be transmitted to the accessory device display unit by the terminal user-interface server application.

6. An accessory device according to the claim 5, wherein the input devices arranged for the accessory device include at least one of a keyboard, buttons, controls, a touch-screen display, or a wireless control unit, control and/or request signals or commands for accessory device input and transmission by the terminal.

7. An accessory device according to claim 5, wherein the accessory device is provided with a GPS antenna in order to receive GPS data, the accessory device transmits the received GPS data as character data over a wireless I ink to the terminal to be processed by the GPS application, and the accessory device receives over a wireless link the results produced by the GPS application as image data to be shown on the accessory device display.

8. An accessory device according to claim 5, wherein the accessory device is set up for voice recognition.

9. An accessory device according to claim 5, wherein the entity forming the user, terminal and accessory device for voice transfer assembly includes a third unit for user-voice reception and terminal-voice repetition, i.e., a second accessory device next to the first one for producing the voice transfer through the accessory device at least for the terminal, whereby optionally the voice is transferred between the second and first accessory device by one link, and the voice and other data is carried between the terminal and the first accessory device through a second link, and there is only one local data-transfer interface in the first accessory device, which handles the data transfer of either link; the voice is transferred from the voice source directly to the terminal through the second accessory device, whereby between the terminal and accessory device two different links exist and the terminal local data-transfer interface handles the data transfer of either link; the first data transfer interface is located in the terminal and both the voice and other-data transfer between the terminal and first accessory device and the voice are transferred through the second link between the first and second accessory device, and in the second accessory device there is one local data-transfer interface and in the first accessory device, there are two local data-transfer interfaces.

10. An assembly preferably containing a communication device or terminal for the at least one of transmission and reception of data, and at least one separate accessory device, wherein the terminal of the assembly includes memory and a processor for executing the application, a character-generator device converting character data so as to be displayed as image data, and a local-data transfer interface, through which the terminal is wirelessly linked to a separate accessory device in order to transfer data to the said accessory device; which includes a local data-transfer interface for the accessory device, through which the accessory device is linked to the terminal, and which accessory device includes devices receiving information to be displayed as visible data; whereby the wireless data-transfer link between the terminal and the accessory device applies a protocol in the assembly that supports data transfer between the terminal and accessory device, wherein a data transfer of the character-generator device, intended to convert the character data to image data and needed for elimination in the accessory device, between the communication network terminal and the accessory device over a wireless connection involves image data rather than character data.

11. An assembly according to the claim 10, wherein the terminaland accessory device form a data-transfer system, wherein the server application of the system-user interface is adapted for the terminal device, and wherein the client application of the system-user interface is adapted for the accessory device, whereby the display accessory or peripheral device is selected from a group that includes mobile-phone car-terminals, desktop computers, portable computers, pocket computers, network or interface-server or server software, cameras, and devices typically constituting independent devices, such as navigation devices, various display, advertising and indicator boards, television sets, video projectors and computer monitors.

12. An assembly according to claim 10, wherein the link between the terminal and the local data transfer interfaces of the accessory device is one of a short-range link, Bluetooth™, WLAN, IrDA (Infrared Data), RF, a short-range wireless transmitter-receiver link, and a transponder link.

13. An assembly according to claim 10, wherein the design of the terminal incorporates a terminal display or server application or part adapted for the terminal application level repeating the terminal and transmitting image data corresponding to the terminal to the accessory device.

14. An assembly according to claim 10, wherein the terminal has a buffer for the accessory device display unit.

15. An assembly according to claim 14, wherein the design of the terminal incorporates a display or server application or part adapted for the terminal application level drawing the whole terminal for the terminal buffer, from which the display image corresponding to the terminal is transferred as image data to the accessory device.

16. An assembly according to the claim 15, the terminal buffer, through which the image data adapted for the accessory device are transmitted to the accessory device, is arranged for the terminal, allowing for different resolutions of the displays for the terminal and accessory device.

17. An assembly according to the claim 16, wherein the buffer enables different resolutions of the accessory device and terminal to be run simultaneously.

18. An assembly according to the claim 14, wherein the design of the terminal incorporates a display or server application or part for the accessory device adapted at a lower level relative to the operating-system application level, preferably at operating system level, drawing the whole terminal user interface for the terminal buffer, from which the display image corresponding to the terminal is transferred as image data to the accessory device.

19. An assembly according to claim 10, wherein the terminal capable of one-way and/or two-way communication is selected from a group that includes:
mobile terminals linked wirelessly to a communication network and intended for telecommunication and/or data transfer, such as various mobile phones and computers;
communication network access servers, and base stations;
stationary or mobile terminals either in fixed or linked connection with a communication network, such as telephones and computers, as well as various alphanumerical terminals exhibiting video and/or still-image and/or other media, such as television sets, indicator and advertising boards and devices, and the like.

20. An assembly according to the claim 19, wherein the terminal is a mobile station.

21. An assembly according to claim 10, wherein the accessory device is provided with a GPS antenna for receiving GPS data, the accessory device transmits the received GPS data over a wireless link as character data to the terminal to be processed in a GPS application adapted for the terminal, and the terminal transmits the results produced by the GPS application over a wireless link to the accessory device in order to display the image data on the accessory-device display.

22. An assembly according to claim 10, wherein the image data are compressed in the terminal and decompressed in the accessory device, whereby the compression/decompression may be a general data compression, an image compression or a moving-image-compression system, such as Zlib, JPEG or MPEG-4, or another compression/decompression system.

23. An assembly according to claim 10, wherein besides image data transferred over a wireless link, voice, multimedia, or data supplementing the image data are transferred.

24. An assembly according to claim 10, wherein the terminal and/or the accessory device (AD) are arranged for voice recognition.
